(19) United States
(12) Patent Application Publication
(10) Pub. No.: US 2026/0303235 A1
(43) Pub. Date: Oct. 1, 2026

(54) Payload-Efficient Differential RSRP Reporting With Time Instance Indicators and Configurable Offsets in AI/ML Beam Management

(71) Applicant: Apple Inc., Cupertino, CA (US)

(72) Inventors: Konstantinos SARRIGEORGIDIS, Los Gatos, CA (US); Jie CUI, San Jose, CA (US); Yang TANG, San Jose, CA (US)

(21) Appl. No.: 19/181,711

(22) Filed: Apr. 17, 2025

(30) Foreign Application Priority Data
Mar. 26, 2025 (GR) 20250100225

(51) Int. Cl. H04B 17/318; H04W 24/10; H04W 72/21

(52) U.S. Cl. CPC H04B 17/328; H04W 24/10; H04W 72/21

(57) ABSTRACT

An apparatus configured to measure a first set of reference signals (RS) for a first set of beams, predict second measurements for a second set of beams from measurements of the first set of RS, the second set of beams corresponding to N future time slots after a latest transmission of the first set of RS, the configuration including an offset value relative to the latest transmission and a prediction window comprising the N future time slots and generate an inference report including an absolute layer 1 reference signal receive power (L1-RSRP) value corresponding to a largest L1-RSRP value predicted for the second set of beams, the largest L1-RSRP corresponding to a first future time slot, a time instance indicator indicating the first future time slot, or at least one differential L1-RSRP value corresponding to a second future time slot different from the first future time slot.

### BACKGROUND

Artificial intelligence (AI) and/or machine learning (ML) processes, e.g., deep learning neural networks, may be used to augment operations for the air interface in a cellular radio access network (RAN), e.g., 5G New Radio (NR) RAN, 6G RAN, etc. The use cases of AI/ML for the air interface include beam management (BM).

### SUMMARY

Some example embodiments are related to an apparatus having memory coupled to processing circuitry, wherein the processing circuitry is configured to measure, based on signaling from a network, a first set of reference signals (RS) for a first set of beams, predict, based on a configuration received from the network, second measurements for a second set of beams from first measurements of the first set of RS for the first set of beams, the second set of beams corresponding to N future time slots after a latest transmission of the first set of RS, the configuration including an offset value relative to the latest transmission of the first set of RS and a prediction window comprising the N future time slots and generate, for transmission to the network as uplink control information (UCI) on a physical uplink shared channel (PUSCH), an inference report including at least one of an absolute layer 1 reference signal receive power (L1-RSRP) value corresponding to a largest L1-RSRP value predicted for the second set of beams, the largest L1-RSRP corresponding to a first future time slot, a time instance indicator indicating the first future time slot, or at least one differential L1-RSRP value corresponding to a second future time slot different from the first future time slot.

Other example embodiments are related to a method for measuring, based on signaling from a network, a first set of reference signals (RS) for a first set of beams, predicting, based on a configuration received from the network, second measurements for a second set of beams from first measurements of the first set of RS for the first set of beams, the second set of beams corresponding to N future time slots after a latest transmission of the first set of RS, the configuration including an offset value relative to the latest transmission of the first set of RS and a prediction window comprising the N future time slots and generating, for transmission to the network as uplink control information (UCI) on a physical uplink shared channel (PUSCH), an inference report including at least one of an absolute layer 1 reference signal receive power (L1-RSRP) value corresponding to a largest L1-RSRP value predicted for the second set of beams, the largest L1-RSRP corresponding to a first future time slot, a time instance indicator indicating the first future time slot, or at least one differential L1-RSRP value corresponding to a second future time slot different from the first future time slot.

### BRIEF DESCRIPTION OF THE DRAWINGS

FIG. 1 shows a diagram of spatial domain AI/ML prediction according to one example.

FIG. 2 shows a diagram of temporal domain AI/ML prediction according to one example.

FIG. 3 shows a signaling diagram for AI/ML based UE-side prediction for beam management according to one example.

FIG. 4 shows a signaling diagram for inference reporting for a UE-side AI/ML model for BM Case 2 according to various example embodiments.

FIG. 5 shows a signaling diagram for inference reporting for the UE-side AI/ML model for BM Case 2 according to one example.

FIG. 6 shows a diagram for an inference report for the UE-side AI/ML model for BM Case 2 according to one example.

FIG. 7 shows an example network arrangement according to various example embodiments.

FIG. 8 shows an example UE according to various example embodiments.

FIG. 9 shows an example base station according to various example embodiments.

### DETAILED DESCRIPTION

The example embodiments may be further understood with reference to the following description and the related appended drawings, wherein like elements are provided with the same reference numerals. The example embodiments relate to operations for reporting inference results for artificial intelligence and/or machine learning (AI/ML) models employed by a user equipment (UE) for beam management (BM). In particular, the example embodiments relate to differential reference signal receive power (RSRP) reporting by a UE employing a UE-side AI/ML model for BM Case 2 (temporal prediction). In some aspects of the example embodiments, a differential RSRP reporting scheme includes the reporting of a single largest RSRP value (absolute Layer 1 RSRP (L1-RSRP)) across all predicted future time instances (N future time instances) and beams and differential reporting (offsets or deltas relative to the largest RSRP value) for remaining time instances (N−1 future time instances). In the example embodiments, the report includes a new field for indicating to the network which of the N predicted time instances contains the largest RSRP value (“best” RSRP value), referred to herein as a time instance indicator. In the example embodiments, the differential RSRPs for the remaining N−1 time instances are reported in ascending order of future time instances (e.g., earliest to latest).

In further aspects of the example embodiments, operations are described for determining a reference time for the earliest time instance to which the N future time instances refer. In the example embodiments, the UE may report its processing time requirements (slot offset parameter(s) “j”) and predictive capabilities (maximum prediction window parameter “N”) in a new capability, referred to herein as BMCase2Capability. In view of the reported capabilities, the network may configure a slot offset and a prediction window. In view of these configured parameters, the differential RSRP reporting clearly indicates to which time instances the reported RSRP values correspond in view of the time instance indicator for the absolute RSRP value and the known (ascending) order of the differential RSRP values.

The example embodiments are described with regard to a user equipment (UE). However, reference to a UE is merely provided for illustrative purposes. The example embodiments may be utilized with any electronic component that may establish a connection to a network and is configured with the hardware, software, and/or firmware to exchange signaling and/or data with the network. Therefore, the UE as described herein is used to represent any electronic component.

The example embodiments are also described with reference to a 5G New Radio (NR) network. However, reference to a 5G NR network is merely provided for illustrative purposes. The example embodiments may be utilized with any network implementing AI/ML beam management functionalities similar to those described herein, e.g., 5G-Advanced network, 6G network, etc. Therefore, the 5G NR network as described herein may represent any type of network implementing AI/ML beam management functionalities similar to the 5G NR network.

The example embodiments are also described with regard to radio resource management (RRM), in particular, beam management (BM). Beam management generally refers to a set of procedures configured to acquire and maintain a beam between a base station or TRP and a UE. The terms P1, P2 and P3 refer to processes for beam management during initial access and while in the CONNECTED state. In the P1 process, the base station (e.g., gNB) performs Tx beam sweeping of synchronization signal blocks (SSBs), typically from a set of different beams, and the UE performs reception (Rx) wide beam sweeping from a set of different beams. The UE measures the signal strength (e.g., Reference Signal Received Power (RSRP)) of each of the SSBs of the received beams and selects the best beam to report to the gNB. In the P2 process, the gNB performs beam refinement by performing Tx beam sweeping of Channel State Information-Reference Signal (CSI-RS), possibly from a smaller set of beams than the P1 process, and the UE performs Rx wide beam sweeping from a set of different beams. The P2 Tx beam sweeping may be narrower than that of P1. The UE measures the signal strength (e.g., RSRP) of the CSI-RS of the received beams and selects the best beam to report to the gNB. In the P3 process the gNB (TRP) repeatedly transmits the same Tx beam and the UE refines its Rx beam.

The example embodiments are also described with regard to AI/ML-based beam management (BM). An AI/ML model may be employed for beam prediction to reduce overhead/latency and improve beam selection. The AI/ML model may be employed for beam prediction in the time domain and/or the spatial domain. In both cases, a set of downlink beams may be measured and used as input to the AI/ML model to predict the best beam within another set of downlink beams. In some example embodiments, the measured parameter/quantity may be L1-RSRP. However, the example embodiments are not limited to this parameter. The measured set of downlink beams may be referred to as “Set B” and the predicted set of downlink beams may be referred to as “Set A.” Set B may be a subset of Set A, or Set B may be different from Set A. For example, the base station may be capable of transmitting 64 beams, but the base station may transmit only 4 beams or 8 beams as the Set B of beams. The AI/ML model may then predict a larger set of beams, e.g., the Set A of beams.

The input into the AI/ML model may be measurement results based on measurements performed by the UE on the Set B of beams. The inputs may also include other inputs such as beam forming assumptions and configuration assumptions used by a base station to transmit the Set B of beams. The AI/ML model uses these inputs to predict a beam report for a Set A of beams, which may include a best beam from the Set A and/or L1-RSRP. The AI/ML model may reside at the UE or at the network (e.g., base station).

Beam management Case 1 (BM-Case1) relates to spatial-domain DL Tx beam prediction for Set A of beams based on measurement results of Set B of beams. Beam management Case 2 (BM-Case2) relates to temporal DL Tx beam prediction for Set A of beams based on the historic measurement results of Set B of beams.

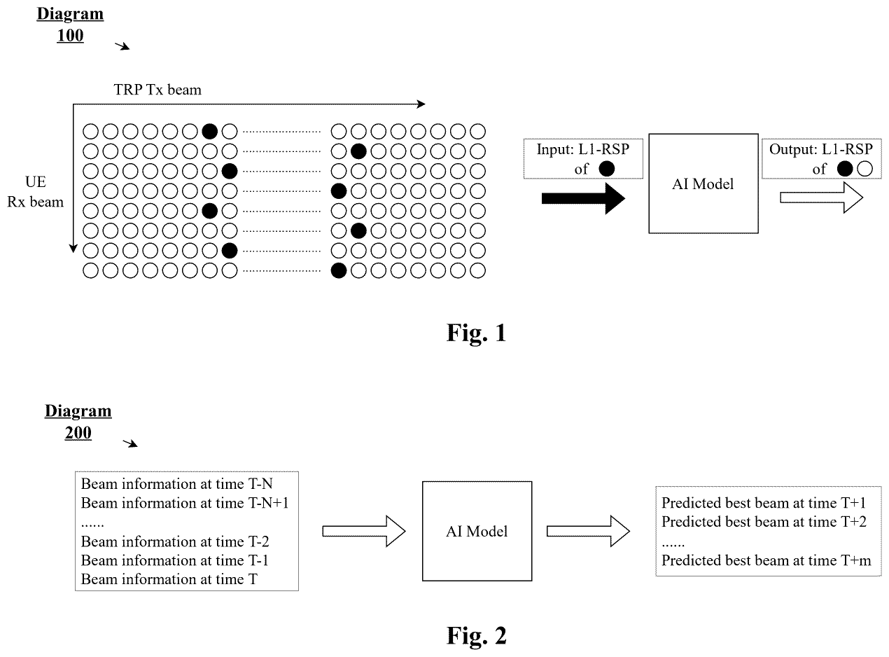

FIG. 1 shows a diagram 100 of spatial domain AI/ML prediction according to one example. The diagram 100 shows a beam pattern of Tx beams and Rx beams. In BM Case 1, the UE measures a subset of beams (Set B) for input to the AI/ML model. The output of the AI/ML model comprises a quality of all beams and/or the ID of the Top-K beams. Thus, the reference signal overhead, the measurement complexity and latency may be reduced.

FIG. 2 shows a diagram 200 of temporal domain AI/ML prediction according to one example. In BM Case 2, the best beam at the future time T+m may be predicted by the AI/ML model based on the measurement results of more than one historical measurement time instance. The measurement results of the historical time instance may include the L1-RSRP of beams in set B in the last N history measurement instance. The number of predicted future time instances may be at least one. Each predicted future time instance may include multiple predicted beams.

For UE-side beam prediction, the beam report may include, for example, beam indices for the Set A of beams, L1 Reference Signal Received Power (RSRP) for the Set A of beams, etc. The beam report for the set A of beams is not based on actual measurements on the set A of beams but is based on a prediction by the AI/ML model using the inputs. The report may include the top K beam measurements (predictions) along with the beam index or may include only the top K beam indices. The network may then use the information from the beam report to perform BM operations in the downlink (DL) such as changing a TCI state for DL transmissions. The AI/ML model may be trained using any data and/or technique and the training of the AI/ML model is beyond the scope of this disclosure.

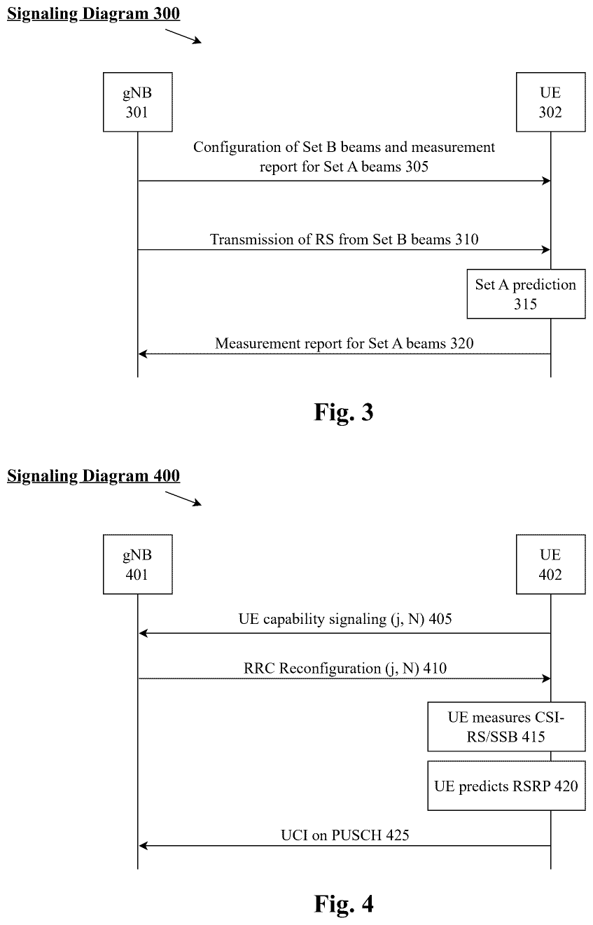

FIG. 3 shows a signaling diagram 300 for AI/ML based UE-side prediction for beam management according to one example. The diagram 300 includes a gNB 301 and a UE 302. In 305, the gNB 301 configures the UE 302 with Set B beams and a measurement report for Set A beams. In 310, the gNB 301 transmits RS from the Set B beams (e.g., SSB or CSI-RS) for measurement by the UE 302. In 315, the UE 302 predicts the Set A beams. In 320, the UE 302 transmits a measurement report corresponding to the Set A beams.

For the UE-sided model for BM-Case 2, for the inference results report, it is an objective to support the configuration of the UE by the network with N future time instance(s) for inference. An open issue is determining the reference time for the earliest time instance to which the N future reporting instances refer, i.e., the starting point of the N future time instances.

The reference time may vary based on UE capabilities, e.g., the processing time for inference. The UE may perform model inference after it measures the channel during the latest transmission occasion of the CSI-RS/SSB resource in Set B. In the earliest case, this could occur in the slot corresponding to that transmission occasion as reported in the measurement.

In various example embodiments described herein, a UE may signal its capabilities for AI/ML BM Case 2. The BM Case 2 capabilities may include one or more supported offset values, e.g., based on the processing time requirements of the UE, and a maximum number of future time instances that may be predicted. In some embodiments, the UE capability signaling may include a new capability referred to herein as BMCase2Capability. The new capability may include a parameter corresponding to one or more supported offset values j, e.g., supportedProcessingOffsets. The offset value j (i.e., the reference time for the N future time instances) is anchored to the latest transmission occasion of CSI-RS/SSB resources in Set B used for channel measurement. The slot containing the latest CSI-RS/SSB transmission in Set B is referred to as slot n. The new capability may further include a parameter corresponding to a maximum prediction window N, e.g., maxPredictiveInstances. Based on the reported capabilities, the network may configure the UE via RRC (3GPP TS 38.331) with an offset j selected from the one or more reported values and a prediction window N less than or equal to the reported maximum value.

In one illustrative example, the UE signals supportedProcessingOffsets=[2, 3, 4] and maxPredictiveInstances=3. The gNB may select an offset value from the set, e.g., processingOffset=3, and a prediction window less than or equal to the maximum, e.g., N=3. The offset j is a gNB-configured value defining the start of future predictions (slot (n+j)). Thus, the UE configured with these values will predict slots (n+2), (n+3) and (n+4).

The inference results of a UE-side model may include quantized L1-RSRP values. It is an objective to support, for a UE-side model for BM-Case 2 (time domain prediction), differential RSRP reporting among multiple beams over multiple time instances. The following two options may be considered for such differential RSRP reporting.

In a first option, across multiple time instances, only one L1-RSRP value corresponding to the largest predicted value among all the time instances and beams is reported. The remaining predicted RSRP may be reported as differential RSRPs. The signaling overhead incurred by the first option comprises 1 absolute RSRP value+N−1 differential RSRP values, where N refers to the prediction window, i.e., a total number of predicted future time instances.

In a second option, for each time instance, one L1-RSRP

corresponding to the largest predicted value across beams for that specific time instance is reported, and the remaining predicted RSRPs across time are then reported as differential RSRPs. The signaling overhead incurred by the second option comprises N absolute RSRP+beam differentials.

According to various example embodiments described herein, operations are described for supporting differential L1-RSRP reporting according to the first option described above in which only one absolute L1-RSRP value is reported and the remaining RSRP are reported as differential RSRPs. The first option may be preferred relative to the second option for its payload efficiency and minor specification overhead.

In some embodiments, the single largest RSRP is reported across all time instances and beams. The UE reports an absolute L1-RSRP for the time instance with the largest predicted RSRP. In some embodiments, in the inference results, the absolute RSRP may comprise 8 bits.

In some embodiments, a new field may be introduced into the report to indicate which relative time instance contains this “best” RSRP. The new field may be referred to herein as a Time Instance Indicator. In some embodiments, the Time Instance Indicator may comprise 2-3 bits. In one example, if N=4, the Time Instance Indicator may comprise 2 bits. If N>4, the Time Instance Indicator may comprise 3 bits.

In some embodiments, the remaining RSRPs are reported as differentials (offsets or deltas) relative to the largest value. In some embodiments, the differential RSRP may comprise 4 bits. In some embodiments, in the inference results, the differential RSRPs are mapped in ascending order of future time instances (e.g., earliest to latest).

In some embodiments, the inference results comprise a time instance indicator and a differential RSRP array reported via uplink control information (UCI) on the physical uplink shared channel (PUSCH).

FIG. 4 shows a signaling diagram 400 for inference reporting for a UE-side AI/ML model for BM Case 2 according to various example embodiments. The diagram 400 includes a gNB 401 and a UE 402. In 405, the UE reports BM Case 2 capabilities including supported offset value(s) j and a maximum prediction window N. In 410, the gNB 401 configures the UE 402 with an offset value j selected from the reported values and a prediction window N less than the maximum reported value. In 415, the UE 402 measures RS from Set B (e.g., SSB or CSI-RS). In 420, the UE 402 predicts RSRP for the Set A beams for the N future time instances. In 425, the UE 402 transmits an inference report as UCI on the PUSCH.

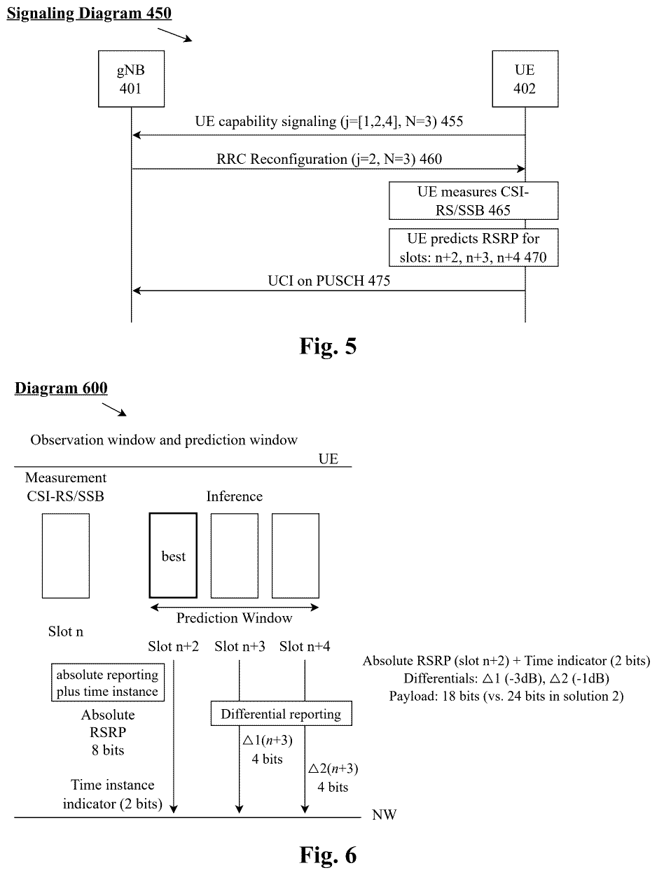

FIG. 5 shows a signaling diagram 450 for inference reporting for the UE-side AI/ML model for BM Case 2 according to one example. FIG. 6 shows a diagram 600 for an inference report for the UE-side AI/ML model for BM Case 2 according to one example.

The diagram 450 of FIG. 5 includes the gNB 401 and the UE 402 of FIG. 4. In this example, in 455, the UE reports BM Case 2 capabilities including supported offset value(s) j=[1,2,4] and a maximum prediction window N=3. In 460, the gNB 401 configures the UE 402 with an offset value j=2 and a prediction window N=3. In 465, the UE 402 measures RS from Set B (e.g., SSB or CSI-RS). The latest CSI-RS/SSB transmission in Set B is transmitted in slot n, as shown in FIG. 6.

In 470, the UE 402 predicts RSRP for the Set A beams for the N=3 future time instances, e.g., slots n+2, n+3 and n+4. In this example, the largest L1-RSRP value is predicted for slot n+2, as shown in FIG. 6. Accordingly, the inference report is constructed to include an absolute RSRP for slot n+2 comprising 8 bits and a Time Instance Indictor value (2 bits) indicating slot n+2, e.g., indicating the first of the N=3 slots. The inference results for the remaining slots n+3 and n+4 are reported as differential RSRP. Accordingly, the inference report is constructed to include a differential RSRP for slot n+3 comprising 4 bits and a differential RSRP for slot n+4 comprising 4 bits.

In 475, the UE 402 transmits an inference report as

UCI on the PUSCH. The inference report has a payload of 18 bits (absolute RSRP (8 bits), Time Instance Indictor (2 bits), differential RSRP (4 bits), differential RSRP (4 bits)). The differential RSRP for slot n+3 is included in the report before the differential RSRP for slot n+4 (ascending order in time).

If the second option discussed above was used for the RSRP reporting, where one L1-RSRP corresponding to the largest predicted value across beams for each predicted time instance is reported, the payload of the inference report would comprise 24 bits. Accordingly, the inference reporting according to the example embodiments (first option) has reduced overhead relative to the second option.

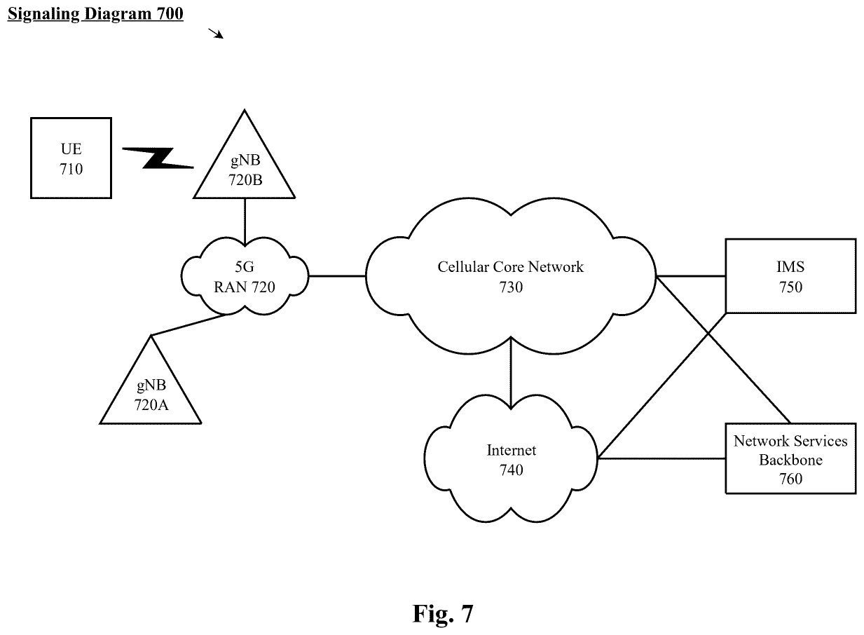

FIG. 7 shows an example network arrangement 700 according to various example embodiments. The example network arrangement 700 includes a UE 710. The UE 710 may be any type of electronic component that is configured to communicate via a network, e.g., mobile phones, tablet computers, desktop computers, smartphones, embedded devices, wearables, Internet of Things (IoT) devices, etc. An actual network arrangement may include any number of UEs being used by any number of users. Thus, the example of one UE 710 is merely provided for illustrative purposes.

The UE 710 may be configured to communicate with one or more networks. In the example of the network arrangement 700, the network with which the UE 710 may wirelessly communicate is a 5G NR radio access network (RAN) 720. However, the UE 710 may also communicate with other types of networks (e.g., 5G cloud RAN, a next generation RAN (NG-RAN), a legacy cellular network, etc.) and the UE 710 may also communicate with networks over a wired connection. With regard to the example embodiments, the UE 710 may establish a connection with the 5G NR RAN 720. Therefore, the UE 710 may have a 5G NR chipset to communicate with the NR RAN 720.

The 5G NR RAN 720 may be portions of a cellular network that may be deployed by a network carrier (e.g., Verizon, AT&T, T-Mobile, etc.). The RAN 720 may include cells or base stations that are configured to send and receive traffic from UEs that are equipped with the appropriate cellular chip set. In this example, the 5G NR RAN 720 includes the gNB 720A and the gNB 720B. However, reference to a gNB is merely provided for illustrative purposes, any appropriate base station or cell may be deployed (e.g., Node Bs, eNodeBs, HeNBs, eNBs, gNBs, gNodeBs, macrocells, microcells, small cells, femtocells, etc.).

Any association procedure may be performed for the UE 710 to connect to the 5G NR RAN 720. For example, as discussed above, the 5G NR RAN 720 may be associated with a particular network carrier where the UE 710 and/or the user thereof has a contract and credential information (e.g., stored on a SIM card). Upon detecting the presence of the 5G NR RAN 720, the UE 710 may transmit the corresponding credential information to associate with the 5G NR RAN 720. More specifically, the UE 710 may associate with a specific cell (e.g., gNB 720A).

The network arrangement 700 also includes a cellular core network 730, the Internet 740, an IP Multimedia Subsystem (IMS) 750, and a network services backbone 760. The cellular core network 730 manages the traffic that flows between the cellular network and the Internet 740. The IMS 750 may be generally described as an architecture for delivering multimedia services to the UE 710 using the IP protocol. The IMS 750 may communicate with the cellular core network 730 and the Internet 740 to provide the multimedia services to the UE 710. The network services backbone 760 is in communication either directly or indirectly with the Internet 740 and the cellular core network 730. The network services backbone 760 may be generally described as a set of components (e.g., servers, network storage arrangements, etc.) that implement a suite of services that may be used to extend the functionalities of the UE 710 in communication with the various networks.

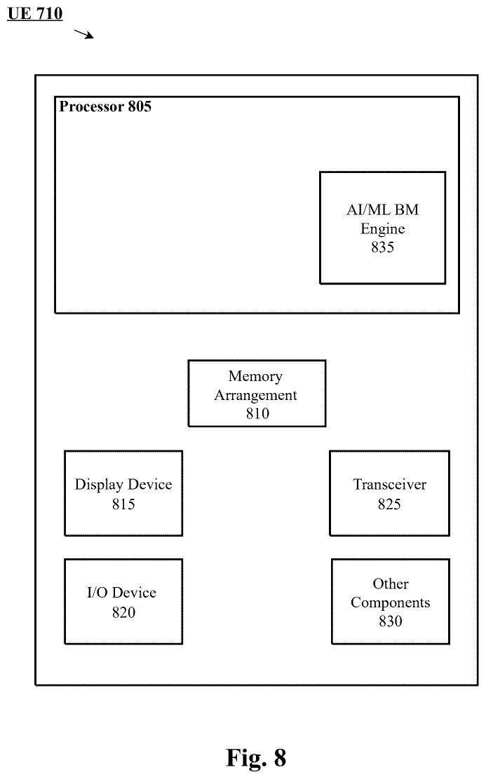

FIG. 8 shows an example UE 710 according to various example embodiments. The UE 710 will be described with regard to the network arrangement 700 of FIG. 7. The UE 710 may represent any electronic device and may include a processor 805, a memory arrangement 810, a display device 815, an input/output (I/O) device 820, a transceiver 825, and other components 830. The other components 830 may include, for example, an audio input device, an audio output device, a battery that provides a limited power supply, a data acquisition device, ports to electrically connect the UE 710 to other electronic devices, sensors to detect conditions of the UE 710, etc.

The processor 805 may be configured to execute a plurality of engines for the UE 710. For example, the engines may include an AI/ML BM engine 835 for performing operations related to inference reporting for the UE-side AI/ML model for BM Case 2, as described in detail above.

In some examples, beam measurement inputs may be fed to the AI/ML BM engine 835. The AI/ML BM engine 835 may include one or more learning-based and/or non-learning-based models for perceiving, synthesizing, and inferring information. The AI/ML BM engine 835 may include any suitable number of processes to predict a beam in the spatial or temporal domain based on input beam measurement data.

Persons of ordinary skill in the art will appreciate that the AI/ML BM engine 835 may include any suitable machine learning models that are well-known or widely available such as regression techniques, classification techniques, neural networks, and deep learning networks. In instances where the AI/ML BM engine 835 comprises a machine-learning based model, the AI/ML BM engine 835 may be trained to predict a beam based on beam measurement data using one or more well-known or widely available training techniques such as supervised learning, semi-supervised learning, unsupervised learning, and/or reinforcement learning techniques. The training data may include the aforementioned beam measurement data.

The above referenced engine being an application (e.g., a program) executed by the processor 805 is only an example. The functionality associated with the engines may also be represented as a separate incorporated component of the UE 710 or may be a modular component coupled to the UE 710, e.g., an integrated circuit with or without firmware. For example, the integrated circuit may include input circuitry to receive signals and processing circuitry to process the signals and other information. The engines may also be embodied as one application or separate applications. In addition, in some UEs, the functionality described for the processor 805 is split among two or more processors such as a baseband processor and an applications processor. The example embodiments may be implemented in any of these or other configurations of a UE.

The memory arrangement 810 may be a hardware component configured to store data related to operations performed by the UE 710. The display device 815 may be a hardware component configured to show data to a user while the I/O device 820 may be a hardware component that enables the user to enter inputs. The display device 815 and the I/O device 820 may be separate components or integrated together such as a touchscreen.

The transceiver 825 may be a hardware component configured to establish a connection with the 5G NR-RAN 720, an LTE-RAN (not pictured), a legacy RAN (not pictured), a WLAN (not pictured), etc. Accordingly, the transceiver 825 may operate on a variety of different frequencies or channels (e.g., set of consecutive frequencies). The transceiver 825 includes circuitry configured to transmit and/or receive signals (e.g., control signals, data signals). Such signals may be encoded with information implementing any one of the methods described herein. The processor 805 may be operably coupled to the transceiver 825 and configured to receive from and/or transmit signals to the transceiver 825. The processor 805 may be configured to encode, decode and/or process signals (e.g., signaling from a base station of a network) for implementing any one of the methods described herein.

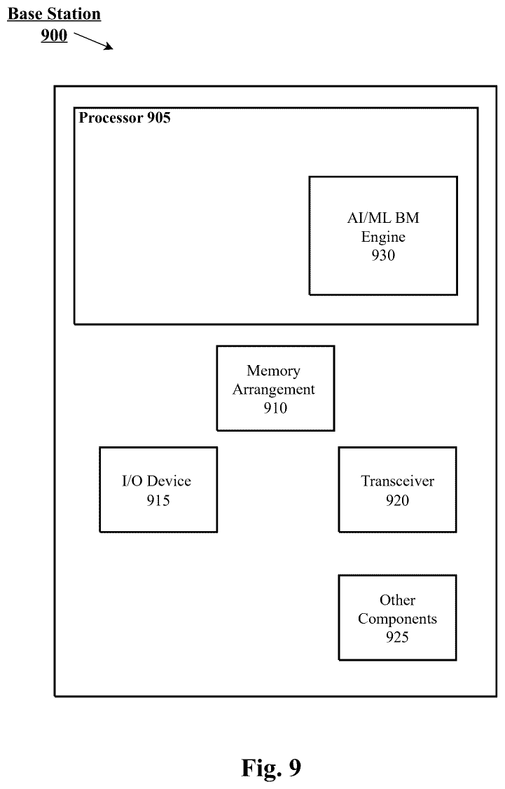

FIG. 9 shows an example base station 900 according to various example embodiments. The base station 900 may represent the gNB 720A, the gNB 720B or any other access node through which the UE 710 may establish a connection and manage network operations. The base station 900 may operate as the MN or the SN as described in the examples above.

The base station 900 may include a processor 905, a memory arrangement 910, an input/output (I/O) device 915, a transceiver 920, and other components 925. The other components 925 may include, for example, an audio input device, an audio output device, a battery, a data acquisition device, ports to electrically connect the base station 500 to other electronic devices and/or power sources, etc.

The processor 905 may be configured to execute a plurality of engines for the UE 710. For example, the engines may include an AI/ML BM engine 930 for performing operations related to configuring inference reporting for the UE-side AI/ML model for BM Case 2, as described in detail above.

In some examples, beam measurement inputs may be fed to the AI/ML BM engine 930. The AI/ML BM engine 930 may include one or more learning-based and/or non-learning-based models for perceiving, synthesizing, and inferring information. The AI/ML BM engine 930 may include any suitable number of processes to predict a beam in the spatial or temporal domain based on input beam measurement data.

Persons of ordinary skill in the art will appreciate that the AI/ML BM engine 930 may include any suitable machine learning models that are well-known or widely available such as regression techniques, classification techniques, neural networks, and deep learning networks. In instances where the AI/ML BM engine 930 comprises a machine-learning based model, the AI/ML BM engine 930 may be trained to predict a beam based on beam measurement data using one or more well-known or widely available training techniques such as supervised learning, semi-supervised learning, unsupervised learning, and/or reinforcement learning techniques. The training data may include the aforementioned beam measurement data.

The memory arrangement 910 may be a hardware component configured to store data related to operations performed by the base station 900. The I/O device 915 may be a hardware component or ports that enable a user to interact with the base station 900.

The transceiver 920 may be a hardware component configured to exchange data with the UE 710 and any other UE in the network arrangement 700. The transceiver 920 may operate on a variety of different frequencies or channels (e.g., set of consecutive frequencies). The transceiver 920 includes circuitry configured to transmit and/or receive signals (e.g., control signals, data signals). Such signals may be encoded with information implementing any one of the methods described herein. The processor 905 may be operably coupled to the transceiver 920 and configured to receive from and/or transmit signals to the transceiver 920. The processor 905 may be configured to encode, decode and/or process signals (e.g., signaling from a UE) for implementing any one of the methods described herein.

### EXAMPLES

In a first example, a method, comprising, measuring, based on signaling from a network, a first set of reference signals (RS) for a first set of beams, predicting, based on a configuration received from the network, second measurements for a second set of beams from first measurements of the first set of RS for the first set of beams, the second set of beams corresponding to N future time slots after a latest transmission of the first set of RS, the configuration including an offset value relative to the latest transmission of the first set of RS and a prediction window comprising the N future time slots and generating, for transmission to the network as uplink control information (UCI) on a physical uplink shared channel (PUSCH), an inference report including at least one of an absolute layer 1 reference signal receive power (L1-RSRP) value corresponding to a largest L1-RSRP value predicted for the second set of beams, the largest L1-RSRP corresponding to a first future time slot, a time instance indicator indicating the first future time slot, or at least one differential L1-RSRP value corresponding to a second future time slot different from the first future time slot.

In a second example, the method of the first example, wherein the inference report includes the time instance indicator indicating one of the N future time slots that contains the largest L1-RSRP value.

In a third example, the method of the first example, wherein the inference report includes the at least one differential L1-RSRP reported as an offset to the largest L1-RSRP value.

In a fourth example, the method of the first example, wherein the inference report includes N−1 differential L1-RSRP values reported in ascending order of time when N is at least 3.

In a fifth example, the method of the first example, further comprising reporting, to the network, in capability signaling, one or more supported offset values j and a maximum number N of future time slots for prediction, wherein the configuration includes the offset value selected from the one or more supported offset values and the N future time slots less than or equal to the maximum number N of future time slots.

In a sixth example, the method of the first example, wherein the capability signaling includes a beam management case 2 capability including parameters j and N.

In a seventh example, the method of the first example, wherein the absolute L1-RSRP value comprises 8 bits and each of the at least one differential L1-RSRP value comprises 4 bits.

In an eighth example, the method of the first example, wherein the time instance indicator comprises 2 bits.

In a ninth example, the method of the first example, wherein the first set of RS comprises channel state information RS (CSI-RS) or synchronization signal block (SSB).

In a tenth example, the method of the first example, wherein the configuration comprises radio resource control (RRC) signaling.

In an eleventh example, a processor configured to perform any of the methods of the first through tenth examples.

In a twelfth example, a user equipment (UE) configured to perform any of the methods of the first through tenth examples.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

Some embodiments described herein may include use of learning and/or non-learning-based process(es). The use may include collecting, pre-processing, encoding, labeling, organizing, analyzing, recommending and/or generating data. Entities that collect, share, and/or otherwise utilize user data should provide transparency and/or obtain user consent when collecting such data. The present disclosure recognizes that the use of the data in the AI/ML beam management processes may be used to benefit users.

For example, the data may be used to train models that may be deployed to improve performance, accuracy, and/or functionality of applications and/or services. Accordingly, the use of the data enables the AI/ML beam management processes to adapt and/or optimize operations to provide more personalized, efficient, and/or enhanced user experiences. Such adaptation and/or optimization may include tailoring content, recommendations, and/or interactions to individual users, as well as streamlining processes, and/or enabling more intuitive interfaces. Further beneficial uses of the data in the AI/ML beam management processes are also contemplated by the present disclosure.

The present disclosure contemplates that, in some embodiments, data used by AI/ML beam management processes includes publicly available data. To protect user privacy, data may be anonymized, aggregated, and/or otherwise processed to remove or to the degree possible limit any individual identification. As discussed herein, entities that collect, share, and/or otherwise utilize such data should obtain user consent prior to and/or provide transparency when collecting such data. Furthermore, the present disclosure contemplates that the entities responsible for the use of data, including, but not limited to data used in association with AI/ML beam management processes, should attempt to comply with well-established privacy policies and/or privacy practices.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

What is claimed:

1. An apparatus comprising memory coupled to processing circuitry, wherein the processing circuitry is configured to:
measure, based on signaling from a network, a first set of reference signals (RS) for a first set of beams;
predict, based on a configuration received from the network, second measurements for a second set of beams from first measurements of the first set of RS for the first set of beams, the second set of beams corresponding to N future time slots after a latest transmission of the first set of RS, the configuration including an offset value relative to the latest transmission of the first set of RS and a prediction window comprising the N future time slots; and
generate, for transmission to the network as uplink control information (UCI) on a physical uplink shared channel (PUSCH), an inference report including at least one of:
an absolute layer 1 reference signal receive power (L1-RSRP) value corresponding to a largest L1-RSRP value predicted for the second set of beams, the largest L1-RSRP corresponding to a first future time slot,
a time instance indicator indicating the first future time slot, or
at least one differential L1-RSRP value corresponding to a second future time slot different from the first future time slot.

2. The apparatus of claim 1, wherein the inference report includes the time instance indicator indicating one of the N future time slots that contains the largest L1-RSRP value.

3. The apparatus of claim 1, wherein the inference report includes the at least one differential L1-RSRP reported as an offset to the largest L1-RSRP value.

4. The apparatus of claim 1, wherein the inference report includes N−1 differential L1-RSRP values reported in ascending order of time when N is at least 3.

5. The apparatus of claim 1, the processing circuitry further configured to:
report, to the network, in capability signaling, one or more supported offset values j and a maximum number N of future time slots for prediction,
wherein the configuration includes the offset value selected from the one or more supported offset values and the N future time slots less than or equal to the maximum number N of future time slots.

6. The apparatus of claim 1, wherein the capability signaling includes a beam management case 2 capability including parameters j and N.

7. The apparatus of claim 1, wherein the absolute L1-RSRP value comprises 8 bits and each of the at least one differential L1-RSRP value comprises 4 bits.

8. The apparatus of claim 1, wherein the time instance indicator comprises 2 bits.

9. The apparatus of claim 1, wherein the first set of RS comprises channel state information RS (CSI-RS) or synchronization signal block (SSB).

10. The apparatus of claim 1, wherein the configuration comprises radio resource control (RRC) signaling.

11. A method, comprising:
measuring, based on signaling from a network, a first set of reference signals (RS) for a first set of beams;
predicting, based on a configuration received from the network, second measurements for a second set of beams from first measurements of the first set of RS for the first set of beams, the second set of beams corresponding to N future time slots after a latest transmission of the first set of RS, the configuration including an offset value relative to the latest transmission of the first set of RS and a prediction window comprising the N future time slots; and
generating, for transmission to the network as uplink control information (UCI) on a physical uplink shared channel (PUSCH), an inference report including at least one of:
an absolute layer 1 reference signal receive power (L1-RSRP) value corresponding to a largest L1-RSRP value predicted for the second set of beams, the largest L1-RSRP corresponding to a first future time slot,
a time instance indicator indicating the first future time slot, or
at least one differential L1-RSRP value corresponding to a second future time slot different from the first future time slot.

12. The method of claim 11, wherein the inference report includes the time instance indicator indicating one of the N future time slots that contains the largest L1-RSRP value.

13. The method of claim 11, wherein the inference report includes the at least one differential L1-RSRP reported as an offset to the largest L1-RSRP value.

14. The method of claim 11, wherein the inference report includes N−1 differential L1-RSRP values reported in ascending order of time when N is at least 3.

15. The method of claim 11, further comprising:
reporting, to the network, in capability signaling, one or more supported offset values j and a maximum number N of future time slots for prediction,
wherein the configuration includes the offset value selected from the one or more supported offset values and the N future time slots less than or equal to the maximum number N of future time slots.

16. The method of claim 11, wherein the capability signaling includes a beam management case 2 capability including parameters j and N.

17. The method of claim 11, wherein the absolute L1-RSRP value comprises 8 bits and each of the at least one differential L1-RSRP value comprises 4 bits.

18. The method of claim 11, wherein the time instance indicator comprises 2 bits.

19. The method of claim 11, wherein the first set of RS comprises channel state information RS (CSI-RS) or synchronization signal block (SSB).

20. The method of claim 11, wherein the configuration comprises radio resource control (RRC) signaling.
